(19) United States
(12) Patent Application Publication
(10) Pub. No.: US 2004/0071614 A1
(43) Pub. Date: Apr. 15, 2004

(54) Device for producing ozone to enhance combustion and oxygenation

(76) Inventor: Alan Frank Kravitz, Roslyn Heights, NY (US)

Correspondence Address: ALAN F. KRAVITZ, 115 WILLOW STREET, ROSLYN HEIGHTS, NY, 11577, US

(21) Appl. No.: 10/261,634

(22) Filed: Sep. 30, 2002

(51) Int. Cl. B01J 19/08; B01J 19/12

(52) U.S. Cl. 422/186.07

(57) ABSTRACT

Oxygen in the air passing through the duct, is converted into ozone for delivery to combustion and oxygenation processes. A conducting element 12 supported on an insulated standoff 13 within a conducting duct 11 has a voltage applied between element 12 and duct 11. This voltage produces a corona on the element whereby ozone is generated. Addition of a grid 24 enhances ozone production. In addition, a provision to vary the voltage on grid 24 whereby the ozone production is controlled further enhances the device. In addition standoff 13 carries supply wire 14 whereby the electrical connection to element 12 is facilitated.

### BACKGROUND

1. Field of Invention

This invention relates to the application of ozone to enhance combustion and oxygenation processes.

2. Description of Prior Art

Though the technology of producing ozone from oxygen in the proximity of an electrical corona is well known, there appears to be no wide-spread commercial application of the energy saving advantages of using ozone in the field of combustion. There is a history of past patents, shown below, which apparently have not gained public acceptance and use. Extensive searching on the Internet has not yielded any references in the literature to ozone enhanced combustion and oxygenation.

English's design, in U.S. Pat. No. 1,873,746 limits the use of his device to internal combustion engines, which are carbureted. It overlooks the use of the device in other combustion devices such as oil and gas burners, gas turbines, and in oxygenation processes. English's design calls for only part of the intake air to flow through the ozone generation section. Additionally, air is allowed to bypass the device, which inhibits the delivery of the generated ozone to the combustion chamber(s).

Persinger's design, in U.S. Pat. No. 4,308,844, has the same limitations as did English's design. Persinger's design also calls for the required additional step of prior removal of moisture from the air to be treated by the ozone generator.

Lee's design, in U.S. Pat. No. 5,010,869 also limits the use of his device to internal combustion engines. It uses pulsed voltage, which limits the amount of ozone produced and available for combustion.

Hall's design, in U.S. Pat. No. 5,596,974, applies continuous RF voltage to the spark plug in an internal combustion engine. This patent is self-limiting. The spark plug has a fixed size and any conversion of oxygen to ozone would be minimal. The only beneficial period available for this conversion is in the intake cycle to combustion.

Klomp's design, U.S. Pat. No. 6,305,363 requires compressed air assist to the ozone generator. It also bypasses untreated air past the ozone generator directly to the engine. Furthermore, the device is limited to internal combustion engines only.

### OBJECTS AND ADVANTAGES

Accordingly, besides the objects and advantages of the ozone-producing device described in my patent, several objects and advantages of the present invention are:

(a) to provide a continuous conversion of oxygen in air within a duct to ozone.

(b) to provide a device by which all the air in a duct is available for ozone conversion.

(c) to provide ozone production within any electrically conductive air-carrying duct where the existing duct becomes a primary element in the device.

(d) to provide an add-on device which can be mounted within a non-conductive duct system and achieve the same results.

(e) to provide a further improvement over pre-existing art by adding a grid which improves the production of ozone.

(f) to provide a method by which varying the voltage on the grid can regulate ozone production.

(g) to provide a standoff, a self contained method of simultaneously connecting and supporting the active element within the duct.

(h) to provide a method to support the element, or elements, axially with extra standoffs within the duct.

Further objects and advantages are to provide an economical method of applying a useful technology to existing combustion or oxygenation systems. The present invention is designed for improving the efficiency of all combustion and oxygenation processes. It is simple to construct and uses the minimal amount of elements to perform its designed function. The elements of the instant device are robust and will capably perform their designated tasks without requiring maintenance or replacement. The instant device provides retro-fitment suitable to presently operating equipment and installations. Additionally, enhanced combustion reduces the fuel required to generate energy for performing any task. The emissions generated by that combustion device are reduced by at least the same percentage as the fuel savings. Still further objects and advantages will become apparent from a consideration of the ensuing description and drawings.

### DRAWINGS FIGURES

FIG. 1 is an overall in perspective view of an embodiment of my invention, including connection to a power supply.

FIG. 2 is a view in perspective of cut away, showing general disposition of internal parts.

FIG. 3 is a view in section through the standoff showing assembly details.

FIG. 4 is a perspective exploded view showing the addition of a grid and ring clamp.

FIG. 5 is a perspective exploded view showing the addition of an insulating ring and connection to the grid.

### REFERENCE NUMERALS IN DRAWINGS

11 duct

12 element

13 standoff

14 supply wire

15 power supply

16 return wire

17 attachment

18 standoff attachment

19 additional standoff

20 wire core

21 feed hole

22 strap

23 ring clamp

24 grid

25 hole

26 fastening nut

27 split pin

28 intake air flow

29 rivet

30 grid connecting wire

31 grid wire fastening

32 insulating ring

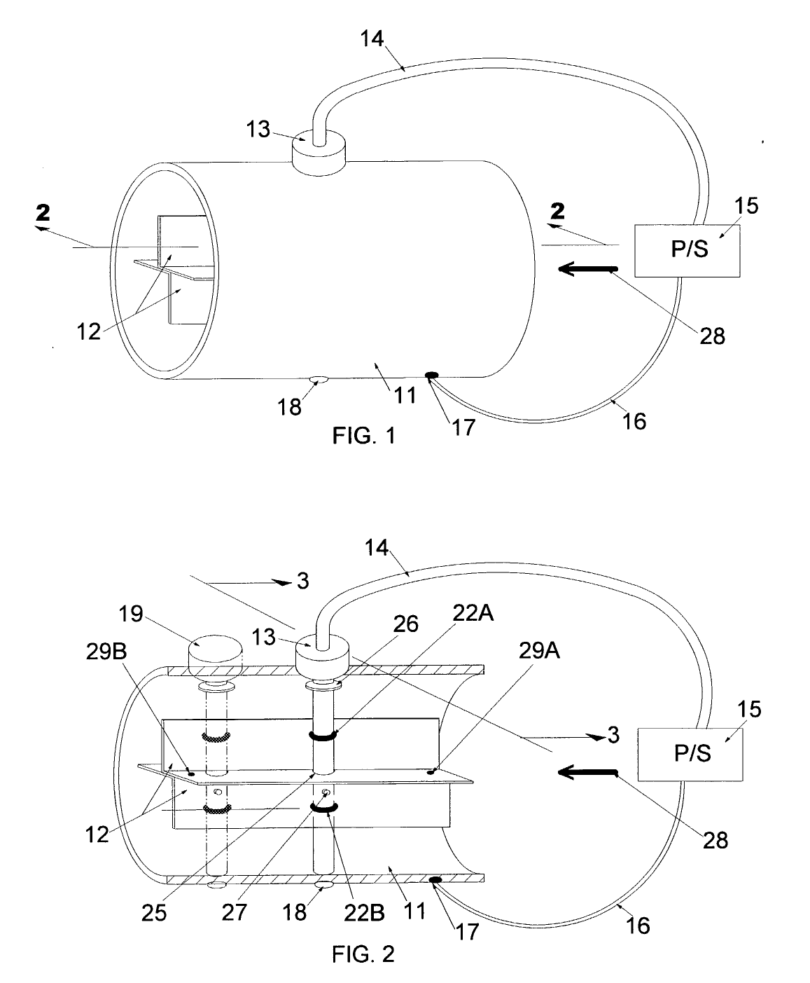

### Description—FIGS. 1 to 5

In this embodiment of the present invention is illustrated in FIG. 1 (a perspective view) and FIG. 2 (a cutaway perspective view). All intake airflow 28 passes through duct 11. The duct is constructed out of an electrically conductive material. Return wire 16 is connected to duct 11 by attachment 17. Return wire 16 is further connected to the return of an electrical power supply 15. Element 12 is disposed axially within duct 11 and is supported on standoff 13. Element 12 is electrically conductive. Standoff 13 is an electrical insulator. In this embodiment element 12 comprises two L shaped structures 12A and 12B, which are held together in two locations by rivet(s) 29A and 29B. In other embodiments the L sections of element 12 can be joined by other methods and can have other configurations. Element 12 has a hole 25 through which standoff 13 passes. Straps 22A and 22B together with split pin 27 secure element 12 to standoff 13 and prevent element 12 from rotating around standoff 13 within duct 11. Fastening nut 26 and standoff attachment 18 secure standoff 13 within duct 11. In another embodiment of my invention standoff 13 could be attached to duct 11 by alternative methods. In other embodiments, if required to support a long element 12 within duct 11, additional standoff(s) 19 can be incorporated. Supply wire 14 connects element 12 to power supply 15. In other embodiments where duct 11 may be of irregular shape element 12 may also be irregular or in multiple sections with multiple supply wires 14. Standoff 19 is for support only and does not have provision for a supply wire 14.

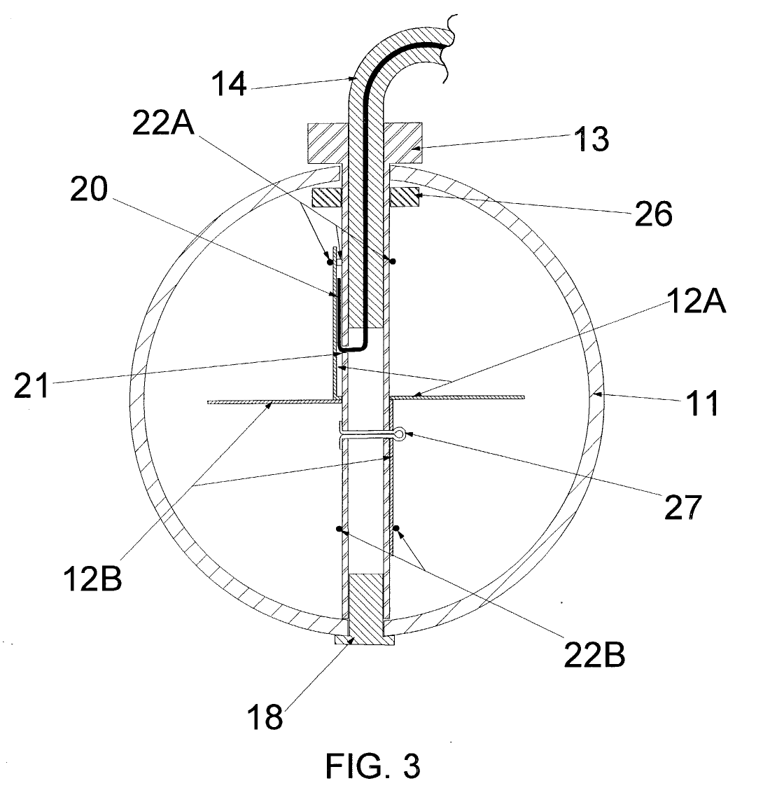

FIG. 3 is a view in section through standoff 13. Supply wire 14 runs axially down the standoff 13. The conducting wire core 20 passes though feedhole 21 in standoff 13 and is trapped between standoff 13 and element 12. The pressure applied by strap 22A ensures electrical contact between wire core 20 and element 12A. A minimum of one standoff 13 is required. Depending on length of element 12 and electrical power requirements and electrical capacity of supply wire 14 an embodiment may require multiple standoffs of type standoff 13. In other embodiments wire 14 can be directly connected to element 12 without passing through the standoff.

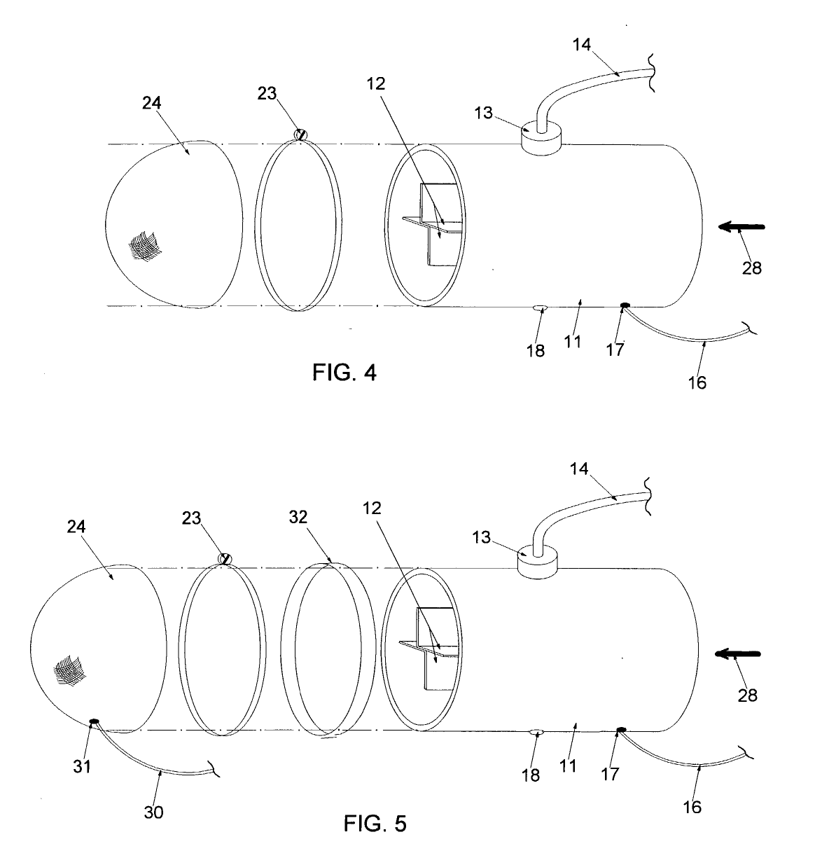

FIG. 4 is a perspective exploded view showing the addition of grid 24, which is held in place by application of ring clamp 23 and makes electrical connection with duct 11.

FIG. 5 is a perspective exploded view showing a further addition of an insulating ring 32 and grid connecting wire 30. Connecting wire 30 is fastened to grid 24 with grid wire fastening 31. In other embodiments, grid wire fastening 31 can be a spot weld or a mechanical device. Insulating ring 32 lies between duct 11 and grid 24, and electrically isolates grid 24. The assembly is secured by ring clamp 23. In other embodiments insulated ring 32, grid 24 and clamp 23 can take other forms.

### Operation—FIGS. 1 to 5

The manner in which this device produces ozone from the air passing through duct 11 is by applying a voltage from power supply 15 between element 12 and duct 11. This voltage is sufficiently high to create a corona between element 12 and duct 11. The spacing between element 12 and duct 11 is great enough to prevent electrical arcing. All the air flowing in duct 11 from air intake flow 28 passes in the space between element 12 and duct 11.

A corona is created when the electric field between element 12 and duct 11 is high enough to tear apart air molecules. The free ions and electrons create conductive plasma, in which electrons and ions recombine, thereby emitting in air a blue light. Ozone, O₃, is produced from the oxygen molecules, O₂, by combining with the oxygen atom, O, from a torn apart oxygen molecule in duct 11.

The sizing of element 12 in duct 11 coupled with the voltage applied is a major factor in determining the amount of ozone produced. Increasing the surface area of element 12 increases the ozone production. Increasing the voltage from power supply 15 increases the ozone production. Voltage increase is limited by the device geometry. The limit is reached when an electric arc occurs between element 12 and duct 11.

My device is inserted and joined into a ducting system carrying air by standard methods including but not limited to welding, flexible couplings or flange couplings. In other embodiments this device can use the existing ductwork, provided this ductwork is electrically conductive.

In FIG. 4 grid 24 is clamped with ring clamp 23 and in electrical contact with duct 11. This increases the effective area at the exit end of duct 11. Element 12 end corona is increased, increasing ozone production.

In FIG. 5 the addition of insulating ring 32 between grid 24 and duct 11 electrically isolates grid 24. By applying a variable voltage to grid 24 via grid connecting wire 30 precise control of ozone output is achieved. As the voltage on grid 24 approaches the voltage on element 12, ozone production is reduced. As the voltage on grid 24 surpasses the voltage on element 12 the corona is further reduced at the end of element 11 closest to grid 24. Conversely as the voltage on grid 24 approaches the voltage on duct 11 ozone production is increased. Ozone production is further increased if the voltage on grid 24 has greater potential-difference, relative to element 12, than the potential-difference between element 12 and duct 11.

### SUMMARY, RAMIFICATIONS, AND SCOPE

Accordingly, the reader will see that this device is used to produce ozone easily and conveniently within a duct carrying air to a combustion or oxygenation process. By adding a grid, ozone production is increased. Furthermore, by adding an electrically isolated grid control of the ozone in the air flowing from the duct may be precisely regulated.

The present invention is designed for improving the efficiency of all combustion and oxygenation processes. It is simple to construct and uses the minimal amount of elements to perform its designed function. The elements of the instant device are robust and will capably perform their designated tasks without requiring maintenance or replacement. The instant device provides retro-fitment suitable to presently operating equipment and installations. Additionally, enhanced combustion reduces the fuel required to generate energy for performing any task. The emissions generated by that combustion device are reduced by at least the same percentage as the fuel savings.

Previously, overly complex devices have been designed which operate in specific limited areas within limited fields of use. The purpose of this design is to be able to universally provide the benefits of substantially more efficient combustion and oxygenation to a world where energy is fast becoming a premium commodity. General applications for this device would include, but not be limited to, gaseous and liquid fuel boilers, gas turbines, external and internal combustion engines, and industrial oxygenation processes.

Although the description above contains much specificity, these should not be construed as limiting the scope of the invention but as merely providing illustrations of some of the presently preferred embodiments of this invention. For example, the element can have other shapes, circular, square, trapezoidal or multi finned. The duct can be of any cross section or can be an existing air carrying part of an existing piece of equipment into which an irregular shaped element, or elements are inserted. The standoffs can have any cross section providing they maintain the position of the element within the duct.

Thus the scope of the invention should be determined by the appended claims and their legal equivalents, rather than by the examples given.

I claim:

1. A device for producing ozone to enhance combustion and oxygenation, comprising:
(a) a duct through which air is passed, said duct being electrically conductive,
(b) a method of connecting said duct to the return of an electrical voltage source,
(c) an element disposed axially within said duct, said element being electrically conductive,
(d) a method of connecting said element to said electrical voltage source,
(e) a single or plurality of supports to hold said element axially within said duct, said supports being insulators,
whereby oxygen in the air passing through the duct, is converted into ozone for delivery to combustion and oxygenation processes.

2. A grid over the end of a duct within which there is an element arranged such that said element has an electrical corona for producing ozone, said grid is electrically conductive, said grid is electrically connected to said duct,
whereby the amount of ozone produced in the duct is increased for delivery to combustion and oxygenation processes.

3. The grid and duct of claim 2, further comprising:
(a) an insulating member, wherein said grid is electrically isolated from said duct,
(b) a method of connecting said grid to a second electrical voltage source,
whereby said second voltage source can be varied to control the amount of ozone produced in the duct for delivery to combustion and oxygenation processes.

4. An electrically insulating standoff supporting a conductive element within a conductive duct, said standoff includes a hole axially through which a wire is passed,
whereby connection to said element is achieved.
